(19) United States
(12) Patent Application Publication
(10) Pub. No.: US 2005/0162088 A1
(43) Pub. Date: Jul. 28, 2005

(54) Flat type fluorescent lamp

(76) Inventor: Kye Seung Lee, Kyonggi-Do (KR)

Correspondence Address: NORRIS, MCLAUGHLIN & MARCUS, P.A., 875 THIRD AVE, 18TH FLOOR, NEW YORK, NY, 10022, US

(21) Appl. No.: 10/509,403

(22) PCT Filed: Mar. 31, 2003
(86) PCT No.: PCT/KR03/00642

(30) Foreign Application Priority Data
Apr. 3, 2002 (KR) 10-2002-0018231
Apr. 3, 2002 (KR) 10-2002-0018232
May 6, 2002 (KR) 10-2002-0024683

(51) Int. Cl. H01J 17/16; H01J 61/30; H01J 61/04

(52) U.S. Cl. 313/634; 313/635; 313/633

(57) ABSTRACT

The present invention discloses a flat type fluorescent lamp that is improved in its light emission efficiency and brightness by installing a tube spacer between 2 panels. A flat type fluorescent lamp includes an outer lamp body comprising front and rear panels, and circumference seal members, and tube spacers installed in the outer lamp body to divide the discharge spaces in plural sections communicating with each other to define a discharge path, a phosphor layer deposited on the outer lamp body and the tube spacers, and a discharge electrode supported on the outer lamp body.

### TECHNICAL FIELD

The present invention relates to a flat type fluorescent lamp and, more particularly, to a fluorescent lamp that is improved in its light emission efficiency and brightness by removing non-light emission area and enlarging light emission area by installing a tube spacer in an outer lamp body, thereby realizing the inventive surface light source.

### BACKGROUND ART

A flat type fluorescent lamp is widely used as a backlight for a flat display panel as well as a lighting device, being increasingly increased in its application field.

A conventional flat type fluorescent lamp comprises two glass substrates and a side plate, which are assembled to each other. Spacers are disposed between the glass substrates to constantly maintain a gap between the substrates, while providing a discharge path. A phosphor is deposited on an inner surface of an outer lamp body, and a discharge electrode is installed on both ends of the side plate. Air in the lamp body is exhausted through an exhaust tube pre-installed on a side of the side plate, and then the exhaust tube is sealed, thereby completing the flat type fluorescent lamp.

One of the spacers are designed to be short at their one ends to form an opening that defines the discharge path with the side plate. Another spacers that are alternately adjacent to one of the spacers are designed to be short at their opposite ends, thereby defining the discharge path in the form of a zigzag-shape. In the above-described conventional flat type fluorescent lamp, when a predetermined voltage is applied to the lamp, electric discharge is incurred between the discharge electrodes, thereby exciting the phosphor to emit light as the surface light source.

Although the above-described flat type fluorescent lamp is good for realizing the surface light source, since it has a non-light emission area, light emission and brightness cannot be constantly realized on the whole surface.

For example, since a plate type spacer is installed in the outer lamp body with the phosphor on the inner surface, the non-light emission area is inevitably formed as large as the thickness of the plate type spacer and there is a limitation in reducing the thickness of the plate type spacer.

Therefore, the conventional flat type fluorescent lamp has deteriorated brightness at a portion where the spacer is installed and excessive brightness at a portion where the spacer is not installed, resulting in a large amount of brightness difference and deteriorating the light emission efficiency in general.

To solve the above problems, a diffuser is disposed on an emission surface of the conventional flat type fluorescent lamp. However, since the diffuser is generally provided for the purpose of compensating for the uniformity by suppressing the light emission at the high brightness area, it deteriorates the overall light emission efficiency. Therefore, there is a limitation in compensating for the brightness by the diffuser as the conventional flat type fluorescent lamp has a large amount of brightness difference.

### SUMMARY OF THE INVENTION

The present invention has been made in an effort to solve the above-described problems of the prior art.

It is an objective of the present invention to provide a flat type fluorescent lamp that is improved in its light emission efficiency and brightness by removing non-light emission area and enlarging light emission area by installing a tube spacer in an outer lamp body, thereby realizing the inventive surface light source.

To achieve the above objective, the present invention provides a flat type fluorescent lamp comprising an outer lamp body sealed to define a discharge space; and tube spacers installed in the outer lamp body to divide the discharge pace and thereby to define a discharge path.

Here, the outer lamp body comprises a front panel, a rear panel, and a circumference seal members formed of tube spacers or flat side plates. The tube spacers have a section formed in one of a circular-shape, an oval-shape and a polygon-shape. The tube spacers may be provided with plural discharge holes or a slot-shaped discharge hole.

Preferably, the tube spacers are alternately arranged with each other and formed shorter than a width of the outer lamp body, thereby forming the discharge path in a zigzag-shape between one ends of the tube spacers and one circumferential seal member.

Alternatively, the tube spacers may be formed extending from one side to the other side of the circumference seal members opposing each other, and a through hole is formed in the vicinity of one end of each of the tube spacers to define the discharge path.

Alternatively, a length of the tube spacer is 1/10-½ of a width of the outer lamp body, the tube spacers are aligned in lines or randomly distributed.

Preferably, a phosphor layer is deposited on an inner and outer surface of the outer lamp body and the tube spacers. A thickness “d” of the phosphor layer is determined to satisfy the following range:
d=4logₑW˜d=4logₑW+16 (where W is electric power of the lamp).

The phosphor layer may be formed of one of a three-wave phosphor material and a phosphor used for a plasma display panel. The phosphor layer deposited on the front panel and the phosphor layer deposited on the rear panel of the outer lamp body are different in a thickness. The thickness of the phosphor layer deposited on the front panel is about 60-70% with respect to that deposited on the rear panel.

According to another embodiment, a phosphor layer is deposited on an outer surface of the front panel of the outer lamp body. At this point, a transparent protecting layer is further deposited on the phosphor layer. Alternatively, a phosphor layer unit is assembled on the front panel of the outer lamp body, the phosphor layer unit comprises a transparent panel, a phosphor layer deposited on the transparent panel, and a transparent protecting layer deposited on the phosphor layer.

Preferably, the flat type fluorescent lamp comprises a discharge electrode supported on the outer lamp body. The discharge electrode is one of a cold cathode and a hot cathode.

Preferably, the flat type fluorescent lamp may further comprise a pair of discharge electrodes disposed opposing inner both sides of the outer lamp body, and the tube spacers are disposed to define a discharge path between the pair of discharge electrodes.

The discharge electrodes are formed of flat plates on surfaces of which grooves or projections are formed. The discharge electrodes are selected from the group consisting of a hollow cathode, a micro hollow cathode, a nano-tube, a carbon nano-tube, a metal wire and a metal hollow wire.

Alternatively, the discharge electrodes may be directly coated on an inner surface of the outer lamp body, and formed of a material selected from the group consisting of diamond-like-carbon, amorphous-carbon, and boron nitrite.

### BRIEF DESCRIPTION OF THE DRAWINGS

FIG. 1 is an exploded perspective view of a flat type fluorescent lamp according to a first embodiment of the present invention;

FIG. 2 is a sectional view of a flat type fluorescent lamp according to the present invention;

FIG. 3 is a perspective view illustrating a modified example of a discharge electrode and an exhaust tube according to the present invention;

FIGS. 4a and 4b are graphs illustrating a comparison of brightness between the conventional art and the present invention;

FIG. 5 is a plane sectional view illustrating a modified example of the first embodiment of the present invention;

FIG. 6 is an exploded perspective view of a flat type fluorescent lamp according to a second embodiment of the present invention;

FIG. 7 is a sectional view of a second embodiment of the present invention;

FIG. 8 is a plan sectional view illustrating a modified example of the second embodiment;

FIG. 9 is a graph illustrating a thickness of a phosphor layer of a third embodiment of the present invention;

FIGS. 10 and 11 are sectional views illustrating a phosphor layer forming structure according to a third embodiment of the present invention;

FIG. 12 is an exploded perspective view of a flat type fluorescent lamp according to a fourth embodiment of the present invention;

FIGS. 13 and 14 are perspective views illustrating a tube spacer constituting the fourth embodiment of the present invention; and

FIGS. 15 to 19 are perspective views illustrating opposing discharge electrodes constituting the fourth embodiment of the present invention.

### EMBODIMENTS

Preferred embodiments of the present invention will be described more in detail in conjunction with the accompanying drawings.

### Embodiment 1

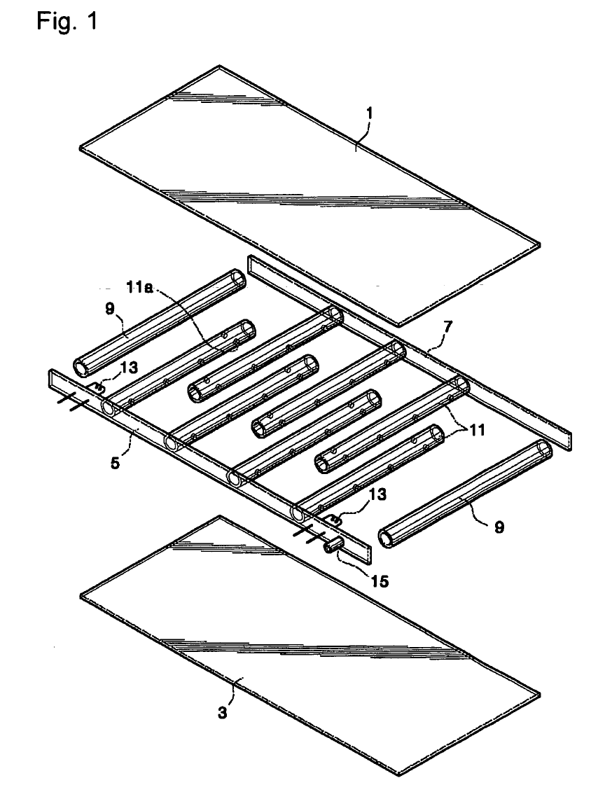

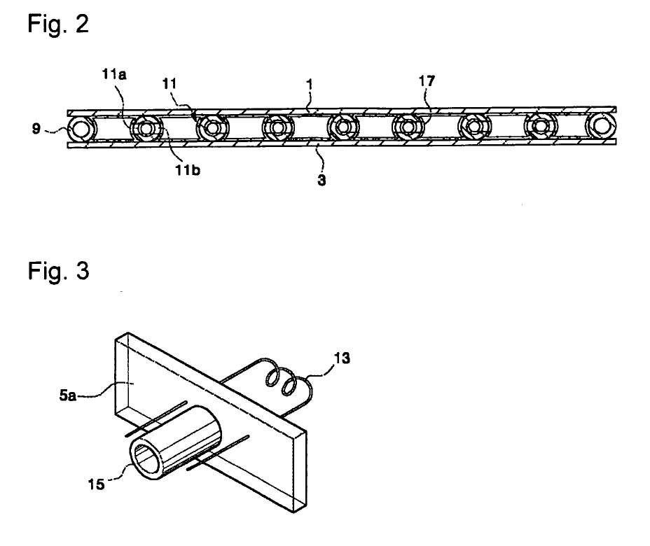

FIGS. 1 and 2 show a flat type fluorescent lamp according to a first embodiment of the present invention.

As shown in the drawings, the inventive flat type fluorescent lamp is defined by a rectangular parallelepiped outer lamp body for realizing a surface light source such as a backlight for a flat display and a lighting device.

The outer lamp body comprises front and rear panels 1 and 3, and longitudinal and lateral seal members 5, 7, and 9 for sealing a space defined between the front and rear substrates 1 and 3. Here, the rear panel 3 and the seal members 5, 7 and 9 are formed of transparent or semi-transparent material. Moreover, a reflection layer may be formed on the rear panel 3.

In addition, the lateral seal members 9 may be formed of tube spacers. Each of the tube spacers 9 has a length identical to that of a width of the outer lamp body. The longitudinal seal members 5 and 7 may be formed of side plates.

As a feature of the invention, plural tube spacers 11 are disposed between the front and rear panels 1 and 3 defining the outer lamp body. The tube spacers 11 divide the discharge space in plural sections that communicate with each other to define a discharge path.

Each of the tube spacers 11 may be designed having a section configured in a circular-shape, an oval-shape, or a polygonal-shape such that it can convert the conventional non-light emission area into the emission area.

As shown in FIG. 2, the phosphor layer 17 is deposited even on the inner and outer circumferences of the tube spacers 11, resulting in enlarging the emission area as the phosphor layer 17 deposited on the inner circumferences of the tube spacers 11 can be excited. Accordingly, uniform light emission can be realized through overall surface of the flat type phosphor lamp, thereby improving the light emission efficiency.

Meanwhile, to enhance the light emission efficiency of the phosphor layer 17 deposited on the inner circumferences of the tube spacers 11, plural discharge holes 11a may be formed on each of the tube spacers 11.

In addition, to define the discharge path, the tube spacers 11 are designed shorter than the width of the outer lamp body. The tube spacers 11 are alternately disposed with each other. One of the tube spacers are adhered to the side plate 7 to define spaces between the side plate 5 and free ends thereof. Another tube spacers 11 are adhered to the side plate 5 to define spaces between the side plate 7 and free ends thereof. Accordingly, by the spaces between the side plates 5 and 7 and the free ends of the tube spacers 11, the discharge path is formed in a zigzag-shape.

The phosphor layer 17 that is the substantial light emission part is uniformly deposited on an inner surface of the outer lamp body. The phosphor layer 17 is deposited on the front and rear panels 1 and 3, the lateral seal members 9 and the tube spacers 11 which are integrally assembled, after which the longitudinal seal members 5 and 7 are assembled, thereby defining the outer lamp body.

Meanwhile, in the present invention, the discharge path defined by the tube spacers 11 is provided at its both ends with discharge electrodes 13. The discharge electrodes 13 can be formed of one of the hot and cold cathodes. When the lamp is a normal lighting device, the hot cathode is used.

The discharge electrodes 13 are installed to be supported on the longitudinal seal members 5 and 7, particularly, on the side plate 5. Although a pair of discharge electrodes 13 is shown in the drawing, the present invention is not limited to this. That is, it is preferable that more than two discharge electrodes are installed when the flat type phosphor lamp is large-sized.

In the above described flat type fluorescent lamp, to make the discharge space of the lamp vacuum state, an exhaust pipe 15 is integrally installed on the longitudinal seal members 5 and 7, particularly on the side plate 5. After the vacuum state is realized, the exhaust pipe 15 is sealed through a thermal-bonding process. As a final process, impurities in the discharge space are removed by a getter.

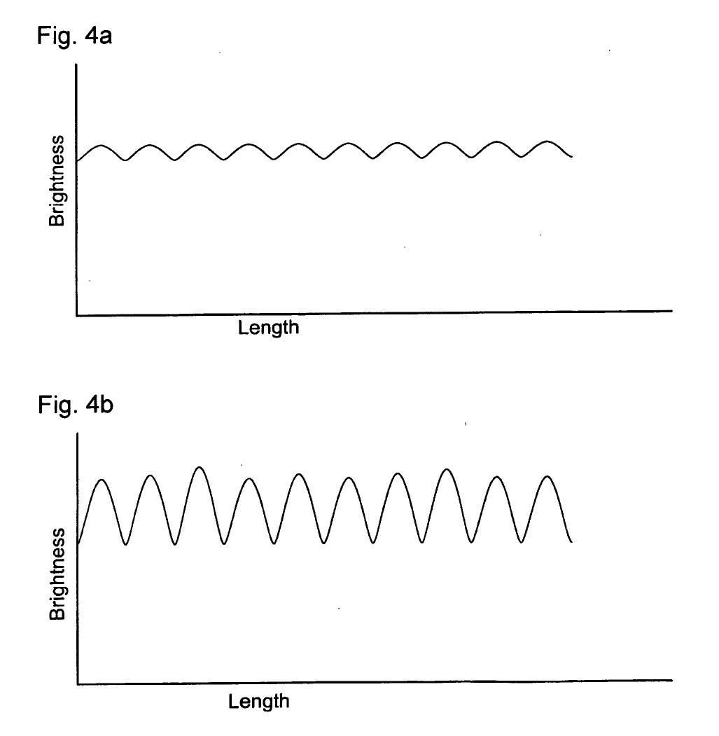

Meanwhile, to make the flat type fluorescent lamp more in easy assembling, as shown in FIG. 3, a stem structure realized by integrating the discharge electrodes 13, the exhaust pipe 15 and a portion 5a of the side plate 5 with each other is provided. The integrated unit is bonded to the lateral seal member 5 in the course of assembling process.

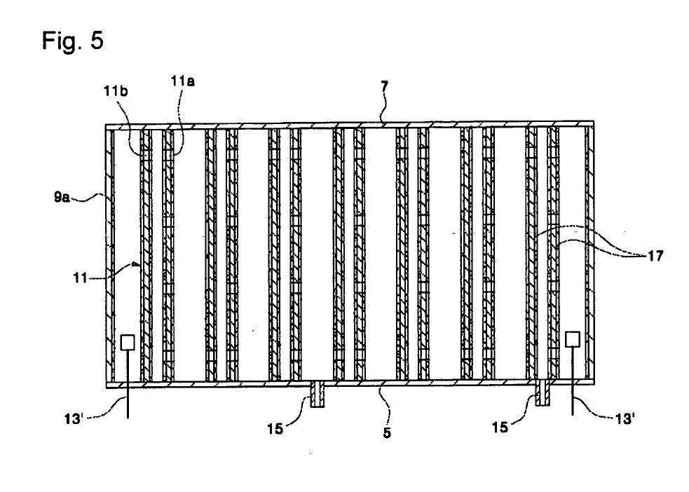

The effect of the above described flat type fluorescent lamp of the present invention will be described hereinafter with reference to FIGS. 4a and 4b. FIG. 4a shows a graph illustrating the brightness of the inventive lamp, and FIG. 4b shows a graph illustrating the brightness of the conventional art. The horizontal line in the graphs indicates the length of the outer lamp body.

As shown in the FIGS. 4a and 4b, the inventive fluorescence lamp completely reduces the brightness difference between a portion where the tube spacers are installed and a portion where the tube spacers are not installed.

Meanwhile, to further improve the uniformity of the brightness, a diffuser can be disposed on a front panel of the flat type fluorescent lamp. Even when the diffuser is disposed, the light emission efficiency of the lamp is not deteriorated.

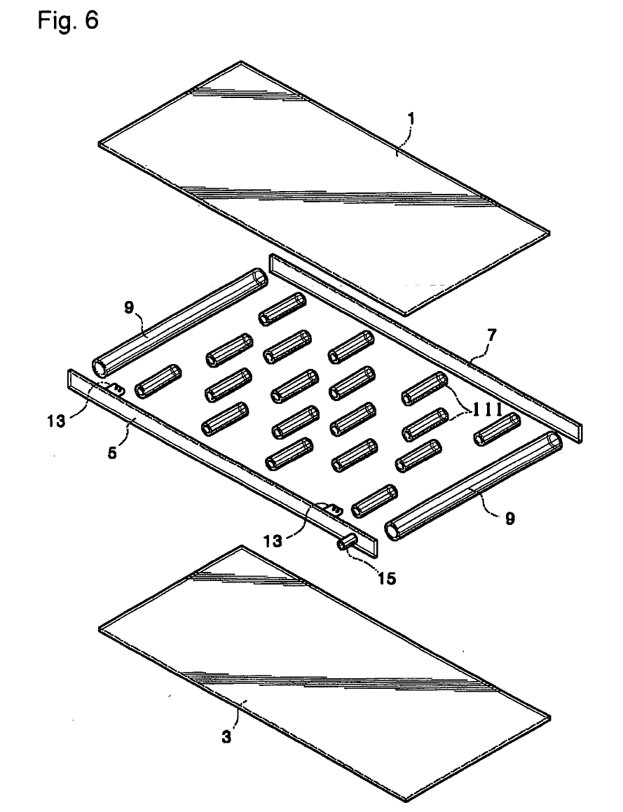

FIG. 5 shows a modified example of the first embodiment.

A flat type fluorescent lamp of this modified example comprises an outer lamp body having front and rear panels 1 and 3 and seal members 5, 7 and 9a, tube spacers 11 disposed between the front and rear panels 1 and 3, a phosphor layer 17 deposited on the inner surface of the outer lamp body and inner and outer circumference of the tube spacers 11, and discharge electrodes 13′ supported on the outer lamp body at opposite ends of a discharge path.

As a feature of this example, the lateral seal member 9a are formed of flat side plates.

Furthermore, the tube spacers 11 are formed extending from the longitudinal seal member 5 to the longitudinal seal member 7 to divide the discharge space in plural sections. The tube spacers 11 are alternately disposed with each other. Incoming holes 11b are formed on the respective tube spacers 11 in the vicinity of the longitudinal seal member 7, and incoming holes 11b are formed on the respective adjacent tube spacers 11 in the vicinity of the longitudinal seal member 5. In addition, plural outgoing holes 11a are formed on each of the tube spacers 11, thereby communicating the divided sections of the discharge space. That is, the discharge path is formed in a zigzag-shape.

In this example, a cold cathode that is proper for a backlight of a flat display is used as discharge electrodes 13′.

In addition, a variety of examples of exhaust pipe 15 are provided in the present invention. As an example, the exhaust pipe 15 can be disposed corresponding to the divided section of the discharge space or in the vicinity of a center of the flat type fluorescent lamp. Alternatively, plural exhaust pipes 15 can be provided. As another example, one of the tube spacers 11 can be disposed penetrating one of the longitudinal seal members 5 and 7 so that it can be used as the exhaust pipe.

### Embodiment 2

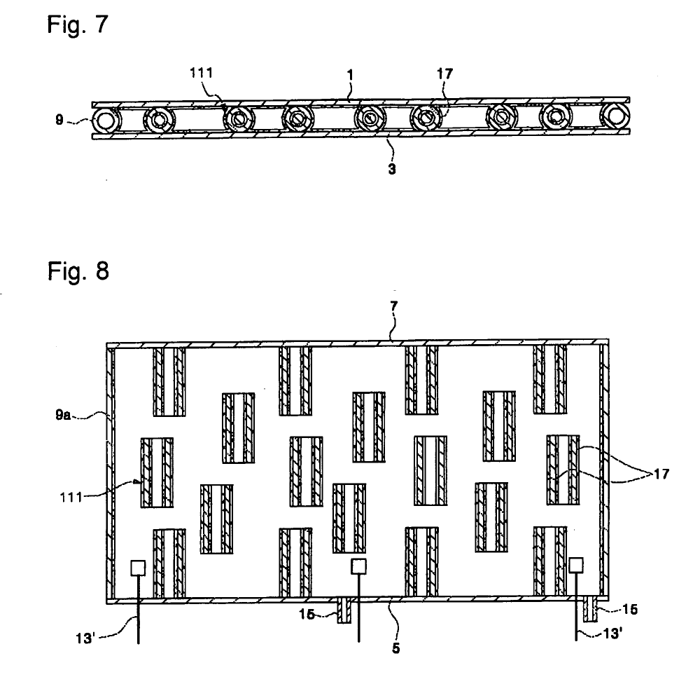

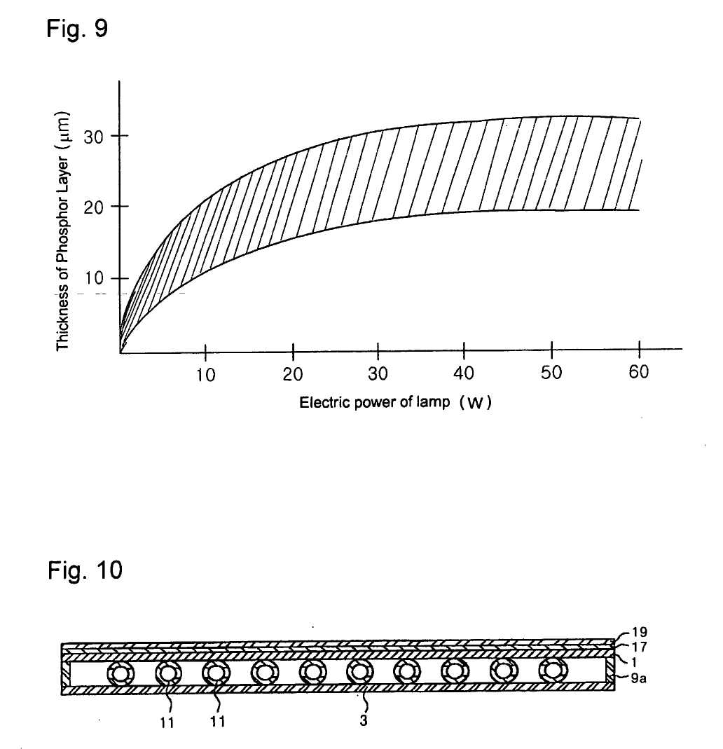

FIGS. 6 and 7 show a flat type fluorescent lamp according to a second embodiment of the present invention.

As shown in the drawings, the inventive flat type fluorescent lamp of this embodiment includes an outer lamp body as in the first embodiment. As a feature of this embodiment, plural tube spacers 111 are disposed between the front and rear panels 1 and 3.

Each of the tube spacers 111 is designed shorter than the width of the outer lamp body. That is, the length of the tube spacer 11 is 1/10-½ of the width of the outer lamp body. The tube spacers 111 can be randomly disposed or aligned in lines. As in the first embodiment, a section of the tube spacer 111 can be designed in a variety of shapes such as a circular-shape, an oval-shape, or a polygonal-shape.

The above described structure and arrangement of the tube spacers 111 according to this embodiment allows the phosphor layer 17 to be more easily deposited to an inner surface of the outer lamp body.

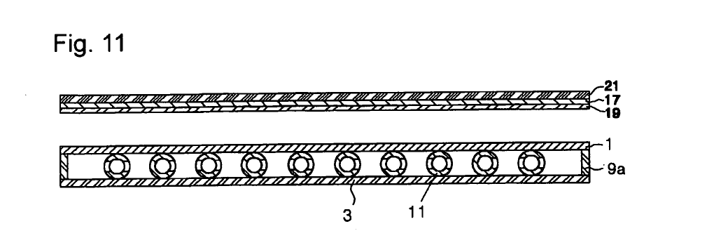

Meanwhile, the discharge electrodes 13 of this embodiment are, as in the first embodiment, formed of one of the hot and cold cathodes. The hot cathodes 13 is employed when the flat type fluorescent lamp is used as a normal lighting device and the cold cathodes 13′ is used when the flat type fluorescent lamp is used as the backlight as shown in FIG. 8.

FIG. 8 shows a modified example of the second embodiment. In this example, the lateral seal members 9a are formed of side plates and the installation of the exhaust pipes 15 is modified.

### Embodiment 3

This third embodiment is identical to the first and second embodiment except that a phosphor layer 17 is further optimized to improve the light emission efficiency and the brightness.

That is, in this third embodiment, a thickness “d” of the phosphor layer 17 deposited on the inner surface of the outer lamp body is defined to satisfy the following range:
d=4logₑW˜d=4logₑW+16
where, W indicates electric power of the lamp.

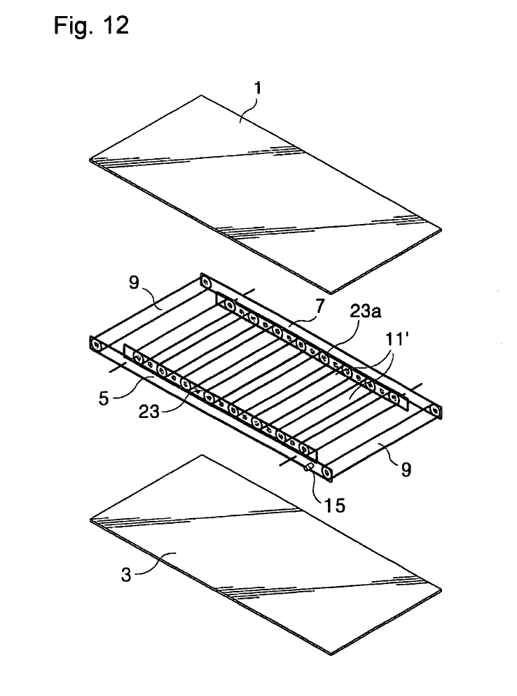

Test results obtained by the above conditions are shown in Table 1 and FIG. 9. In the test, a three-wavelength phosphor is used as the phosphor material, and Y₂O₃:Eu, LaPO₄:Ce,Tb, and (Sr,Ca,Ba)₁₀(PO₄)₆C₁₂:Eu are respectively used for red R, green G and blue B colors of the phosphor material. In addition, the phosphor has a mean particle size in a range of 2-10 μm and is deposited on 80±10% with respect to the entire surface area.

Alternatively, phosphor material used for a plasma display panel (PDP) can also be used as the phosphor. The phosphor material for the PDP is one that can match with ultraviolet rays generated by inertia gas. The phosphor material for the PDP and the three-wavelength phosphor are exiting luminescent phosphors with ultraviolet rays.

TABLE 1

| | Electric Power | | | | | |
|---|---|---|---|---|---|---|
| | 10 W | 20 W | 30 W | 40 W | 50 W | 60 W |
| Thickness(μm) | 11-22 | 13-26 | 15-28 | 15-30 | 16-30 | 17-32 |

The thickness of the phosphor layer shown in Table 1 and FIG. 9 are results obtained from plural tests. When the thickness of the phosphor layer is out of the above thickness range, d=4logₑW˜d=4logₑW+16, that is, when the thickness of the phosphor layer is too thin or thick, it has been noted that the ultraviolet rays cannot be effectively utilized, thereby deteriorating the brightness. Identical result has been applied to the electric power of the lamp per unit area of the phosphor layer.

Meanwhile, in this third embodiment, the phosphor layer 17 may be deposited only on the front panel 1. The phosphor layer 17 deposited on the front panel 1 and the phosphor layer 17 deposited on the rear panel 3 can be formed in a different thickness from each other. In this case, it is preferable that the thickness of the phosphor layer on the front panel 1 is about 60-70% of that on the rear panel 3.

Meanwhile, as a modified example of the third embodiment, the phosphor layer is deposited on an outer surface of the outer lamp body to improve the quality of the phosphor layer and prolong the life span of the lamp.

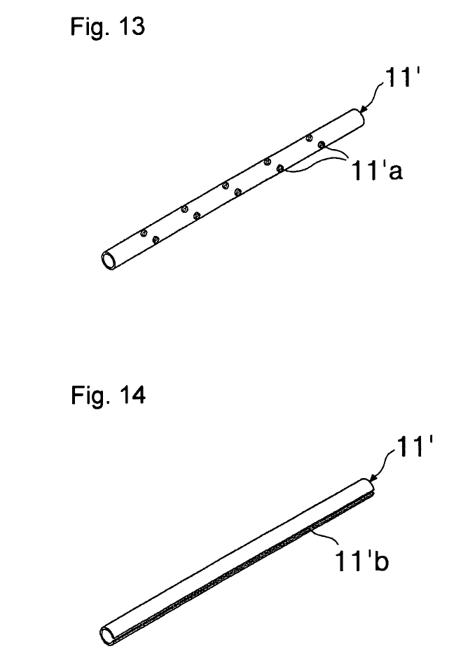

That is, as shown in FIG. 10, the phosphor layer 17 is deposited on the outer surface of the front panel 1 and a transparent protecting layer 19 is deposited on the phosphor layer 17.

Here, the phosphor layer 17 is deposited on the flat and uniform front panel 1 after the outer lamp body is formed through thermal-bonding process, the inner discharge gas is injected, and the discharge electrodes are sealed. The uniform phosphor layer can be obtained through a precipitation process, a printing process or a spray process. Therefore, since the phosphor layer 17 is not subject to the high temperature generated in the course of the thermal bonding process of the outer lamp body and is not affected by mercury generated within the outer lamp body, the life span of the lamp can be prolonged.

The phosphor layer 17 is formed of material that can emit fluorescent light by ultraviolet rays generated within the outer lamp body. At this point, the front panel 1 defining the outer lamp body is preferably formed of material such as quartz that can allow ultraviolet rays to transmit therethrough.

FIG. 11 shows a modified example of the third embodiment of the present invention. In this example, a specially prepared phosphor layer unit is assembled on the outer lamp body.

The phosphor layer unit comprises a transparent panel 21, a phosphor layer 17 deposited on the transparent panel 21, and a transparent protecting layer 19 formed on the phosphor layer 17.

### Embodiment 4

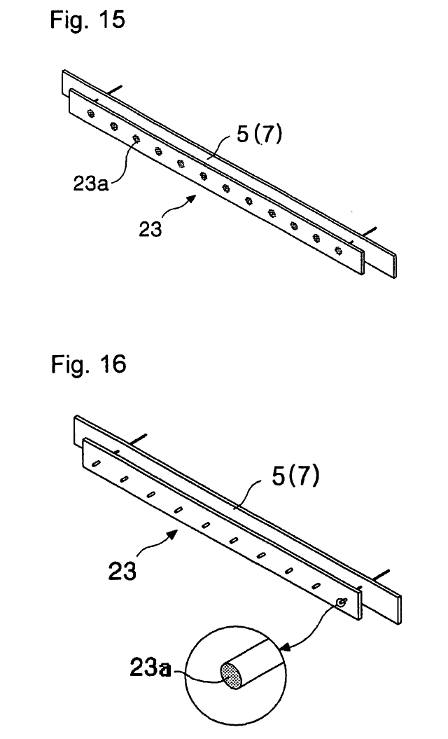

FIG. 12 shows a flat type fluorescent lamp according to a fourth embodiment of the present invention.

As shown in the drawing, the inventive flat type fluorescent lamp of this embodiment comprises the lamp outer body and tube spacers disclosed in the first embodiment and the phosphor layer disclosed in the third embodiment.

However, in this fourth embodiment, a tube spacer 11′ for partly defining an inline discharge path is installed in the outer lamp body, and a pair of opposing discharge electrodes 23 are installed on opposite end of the inline discharge path, being supported by the longitudinal seal member 5 and 7.

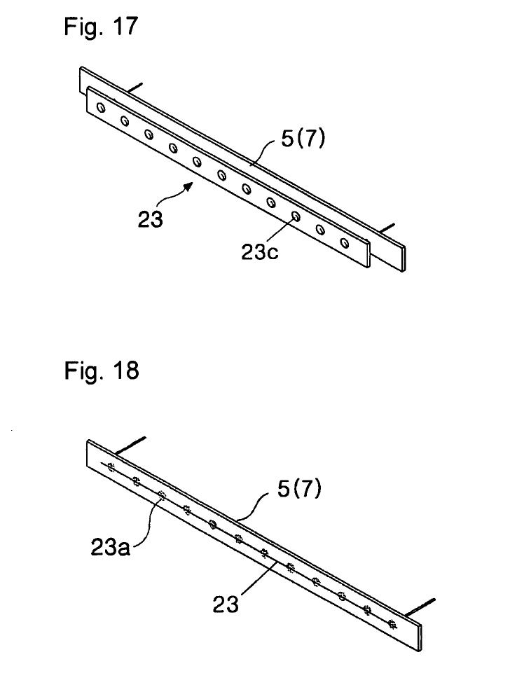

In this embodiment, plural discharge holes 11′a are formed on each of the tube spacers 11′ as shown in FIG. 13. Alternatively, as shown in FIG. 14, a discharge slot 11′b may be formed on each of the tube spacers 11′ in a longitudinal direction of the spacer 11′. Alternatively, as shown in FIG. 12, no discharge hole can be formed on the tube spacers 11′.

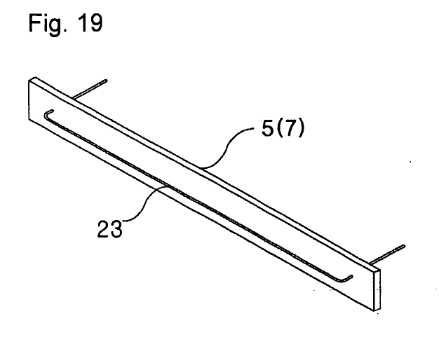

As shown in the enlarged view of FIG. 15, the opposing discharge electrodes 23 is formed in a strip-shape. Grooves or projections are formed on the electrodes 23 through a sanding, etching, injection or other physical processes, thereby enlarging the surface are of the electrodes.

Alternatively, as shown in FIG. 16, the electrodes 23 may be formed with hollow cathodes, micro hollow cathodes, nano-tubes or carbon nano-tubes. In addition, the grooves or projections 23a may be further formed on the surface of the electrodes 23.

FIG. 17 shows a structure where grooves 23c are formed on the opposing discharge electrodes 23.

FIG. 18 shows a structure in which, to define the opposing discharge electrodes 23, electrode material is directly coated on the longitudinal seal members 5 and 7 and the grooves or projections 23a are further formed.

FIG. 19 shows a modified example of the opposing discharge electrodes 23 that is formed of a metal wire or a metal hollow wire. At this point, grooves through which the opposing discharge electrode 23 can run may be formed on opposite end sides of the spacer 11′.

The opposing discharge electrodes 23 formed as in the above are formed of conventional electrode material such as Ni, Nb, W, Mo and so on. Particularly, diamond-like-carbon, amorphous-carbon, and boron nitrite can be also used as material for making the electrodes 23.

Meanwhile, the opposing discharge electrodes 23 can be formed in plural pairs.

By the structure of this fourth embodiment, the flat type fluorescent lamp can obtain the short inline discharge path, resulting in making it possible to allow the partly inline discharge. Furthermore, since the inner and outer portions of the space become the discharge path, the light emission efficiency can be improved and the uniform brightness can be realized. In addition, the lamp can be driven with low voltage.

### Industrial Applicability

As described above, the inventive fluorescent lamp is designed to be improved in its light emission efficiency, brightness, and brightness uniformity by removing non-light emission area and enlarging light emission area by installing a tube spacer in an outer lamp body, thereby realizing the inventive surface light source.

In addition, the inventive flat type fluorescent lamp is designed to optimize the balance of color temperature and color coordinates of the visible light by optimizing the relationship between a thickness of the phosphor layer and electric power, thereby improving brightness and the brightness uniformity.

Furthermore, when the phosphor layer is formed on an outer surface of the outer lamp body according to one embodiment of the present invention, the quality and life span of the lamp can be improved.

Meanwhile, since the light emission can be realized even in the inner portion of the tube spacer by partly realizing the inline discharge, the light emission efficiency and the brightness can be further improved. In addition, the shortened discharge path can reduce the electric power consumption.

1. A flat type fluorescent lamp comprising:
an outer lamp body sealed to define a discharge space; and
tube spacers installed in the outer lamp body to divide the discharge space and thereby to define a discharge path.

2. A flat type fluorescent lamp of claim 1 wherein the outer lamp body comprises a front panel, a rear panel, and circumference seal members formed of tube spacers or flat side plates.

3. A flat type fluorescent lamp of claim 1 wherein the tube spacers have a section formed in one of a circular-shape, an oval-shape and a polygon-shape.

4. A flat type fluorescent lamp of claim 1 wherein the tube spacers are alternately arranged with each other and formed shorter than a width of the outer lamp body, thereby forming the discharge path in a zigzag-shape between one ends of the tube spacers and one circumferential seal member.

5. A flat type fluorescent lamp of claim 1 wherein the tube spacers are alternately arranged in parallel and extending from one side to the other side of the circumferential seal members opposing each other, through holes are being formed in the vicinity of one end of each of the tube spacers to define the discharge path.

6. A flat type fluorescent lamp of claim 1 wherein the tube spacer is further provided with plural discharge holes or a slot-shaped discharge hole.

7. A flat type fluorescent lamp of claim 1 wherein a length of the tube spacer is shorter than a width of the outer lamp body, the tube spacers are aligned in lines or randomly distributed.

8. A flat type fluorescent lamp of claim 1 wherein a phosphor layer is deposited on the outer or/and inner surfaces of the outer lamp body and the tube spacers.

9. A flat type fluorescent lamp of claim 8 wherein a thickness “d” of the phosphor layer is determined to satisfy the following range:
d=4logₑW˜d=4logₑW+16 (where W is electric power of the lamp).

10. A flat type fluorescent lamp of claim 8 wherein the phosphor layer is deposited by using exiting luminescent phosphors with ultraviolet rays.

11. A flat type fluorescent lamp of claim 8 wherein the phosphor layer deposited on the front panel and the phosphor layer deposited on the rear panel of the outer lamp body are different in a thickness.

12. A flat type fluorescent lamp of claim 11 wherein the thickness of the phosphor layer deposited on the front panel is about 60-70% with respect to that deposited on the rear panel.

13. A flat type fluorescent lamp of claim 8 wherein the phosphor layer is deposited only on an inner surface of the front panel of the outer lamp body.

14. A flat type fluorescent lamp of claim 1 wherein the phosphor layer is deposited on an outer surface of the front panel of the outer lamp body.

15. A flat type fluorescent lamp of claim 14 wherein a transparent protecting layer is further deposited on the phosphor layer.

16. A flat type fluorescent lamp of claim 1 wherein a phosphor layer unit is assembled on the front panel of the outer lamp body, the phosphor layer unit comprises a transparent panel, a phosphor layer deposited on the transparent panel, and a transparent protecting layer deposited on the phosphor layer.

17. A flat type fluorescent lamp of claim 1 further comprising a discharge electrode supported on the outer lamp body.

18. A flat type fluorescent lamp of claim 17 wherein the discharge electrode is one of a cold cathode and a hot cathode.

19. A flat type fluorescent lamp of claim 1 further comprising a pair of discharge electrodes disposed opposing inner both sides of the outer lamp body, and the tube spacers are disposed to define a discharge path between the pair of discharge electrodes.

20. A flat type fluorescent lamp of claim 19 wherein the discharge electrodes are formed of flat plates on surfaces of which grooves or projections are formed.

21. A flat type fluorescent lamp of claim 19 wherein the discharge electrodes are selected from the group consisting of a hollow cathode, a micro hollow cathode, a nano-tube, a carbon nano-tube, a metal wire and a metal hollow wire.

22. A flat type fluorescent lamp of claim 19 wherein the discharge electrodes is coated on an inner surface of the outer lamp body.

23. A flat type fluorescent lamp of claim 19 wherein the discharge electrodes are formed of a material selected from the group consisting of diamond-like-carbon, amorphous-carbon, and boron nitrite.
